(19) United States
(12) Patent Application Publication
(10) Pub. No.: US 2013/0222147 A1
(43) Pub. Date: Aug. 29, 2013

(54) PORTABLE WARNING SYSTEM

(71) Applicants: Ji-Yeon Baek, Yongin-si (KR); Kea-Min Jeon, Daejeon (KR); Hyo-Jung Lee, Daejeon (KR); Ki-Young Nam, Seoul (KR)

(72) Inventors: Ji-Yeon Baek, Yongin-si (KR); Kea-Min Jeon, Daejeon (KR); Hyo-Jung Lee, Daejeon (KR); Ki-Young Nam, Seoul (KR)

(21) Appl. No.: 13/609,104

(22) Filed: Sep. 10, 2012

(30) Foreign Application Priority Data
Feb. 28, 2012 (KR) 20-2012-0001551

(51) Int. Cl. G08B 5/00; G09F 9/33

(52) U.S. Cl. 340/815.45; 340/815.4

(57) ABSTRACT

A portable warning system includes a flexible display unit, a fixing member coupled to one side of the display unit, and a supporting member coupled to the fixing member and having a bar shape.

### CROSS-REFERENCE TO RELATED APPLICATION

This application claims priority to and the benefit of Korean Patent Application No. 20-2012-0001551 filed in the Korean Intellectual Property Office on Feb. 28, 2012, the entire contents of which are incorporated herein by reference.

### BACKGROUND

(a) Field

Embodiments of the present invention relate to a portable warning system.

(b) Description of Related Art

A portable warning system is used to signal drivers of approaching cars when a car is stopped on a road, such as an expressway, due to an accident or a breakdown.

If the portable warning system is installed (e.g., erected, or set up), the driver of the following car may see the tripod, or if the driver hits the tripod, the driver is nonetheless alerted to the presence of the stalled car, thereby preventing a secondary accident.

This portable warning system that is used for an emergency is typically stored beside a driver's seat or in a storage box or trunk to allow for quick use in the case of an emergency.

Also, if an accident is generated, the portable warning system is installed behind the accident and at a predetermined distance from the accident position such that the drivers of approaching cars can be sufficiently forewarned of the accident situation.

However, the driver must set up the portable warning system some distance from the accident such that it may be difficult to verify how far the scene of the accident is from the portable warning system, and it is not easy for the drivers of following cars, after recognizing the portable warning system, to know how far the accident scene is from the portable warning system, thereby increasing the risk of an additional accident.

The above information disclosed in this Background section is only for enhancement of understanding of the background of embodiments of the invention, and therefore it may contain information that does not form the prior art that is already known in this country to a person of ordinary skill in the art.

### SUMMARY

Embodiments of the present invention provide a portable warning system capable of securely warning a driver of a following car of a scene of an accident by easily calculating a distance between the accident scene and the portable warning system when setting up the portable warning system (e.g., installing/erecting the portable warning system on a road).

A portable warning system according to an exemplary embodiment of the present invention includes a flexible display unit, a fixing member coupled to one side of the display unit, and a supporting member coupled to the fixing member and having a bar shape.

The display unit may include an organic light emitting device.

The display unit may include a transparent substrate on which the organic light emitting device is located.

The supporting member may include a hinge coupled to the fixing member, a first bar coupled to an end of the hinge, and a second bar coupled the first bar, and the first bar may be movable with respect to the second bar.

The first bar may be coupled to the hinge using a ball-and-socket joint.

The fixing member may include a groove, and one side of the display unit may be fixably inserted into the groove.

The display unit may have a planar shape.

The portable warning system may further include a distance measuring system for calculating a distance from the portable warning system to one or more of a scene of an accident, a construction site, a pedestrian crossing, or a detour.

The flexible display unit may be collapsible around the supporting member.

The portable warning system according to embodiments of the present invention may be set up at a position where a driver of a following car is safely forewarned of an upcoming accident scene. Also, the driver of the following car may easily confirm (from a display of the portable warning system) a distance from the portable warning system to the accident scene to be forewarned such that a secondary accident may be avoided.

Also, the driver of the following car may be provided information of the situation of the accident scene by the portable warning system without interference such that the driver of the following car may be forewarned.

### BRIEF DESCRIPTION OF THE DRAWINGS

FIG. 1 to FIG. 4 are respectively a front view, a rear view, a side view, and a bottom view of a portable warning system according to an exemplary embodiment of the present invention.

FIG. 5 is a perspective view of a display unit displaying an alert according to an exemplary embodiment of the present invention.

FIG. 6 is a perspective view showing a storage state of a portable warning system according to an exemplary embodiment of the present invention.

### DETAILED DESCRIPTION

Embodiments of the present invention will be described more fully hereinafter with reference to the accompanying drawings, in which exemplary embodiments of the invention are shown. As those skilled in the art would realize, the described embodiments may be modified in various ways without departing from the spirit or scope of the present invention.

The drawings are schematic, and are not necessarily proportionally scaled down. Relative scales and ratios in the drawings may be enlarged or reduced for the purpose of accuracy and convenience, and the scales may be random, and are not limited thereto. In addition, like reference numerals designate like structures, elements, or parts throughout the specification. It will be understood that when an element is referred to as being “on” another element, it can be directly on another element or intervening elements may be present therebetween.

Exemplary embodiments of the present invention described with reference to the drawings represent ideal exemplary embodiments of the present invention in detail. Therefore, various modifications may be expected. Accordingly, exemplary embodiments are not limited to specific shapes of shown regions, and for example, may also include modifications of the shape via manufacturing.

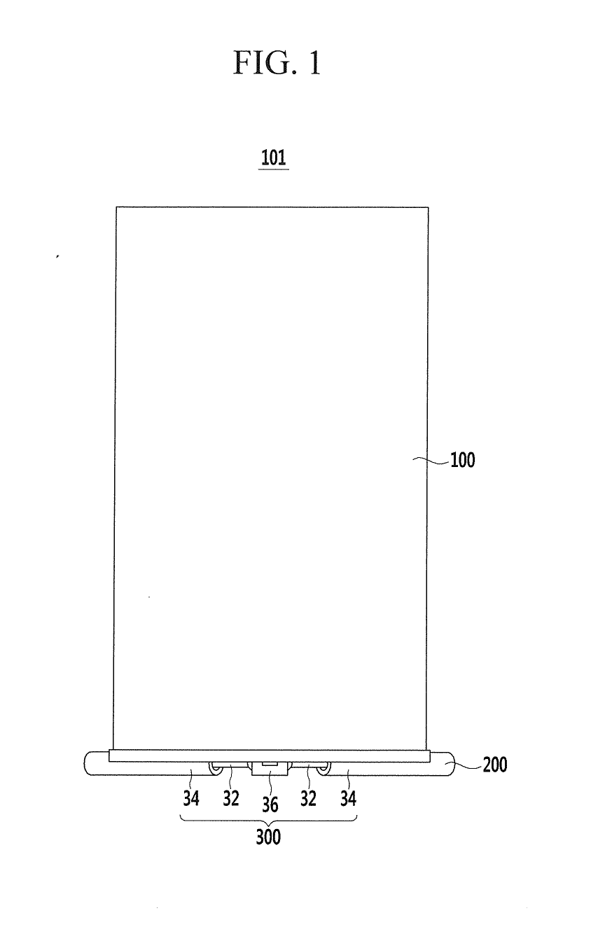

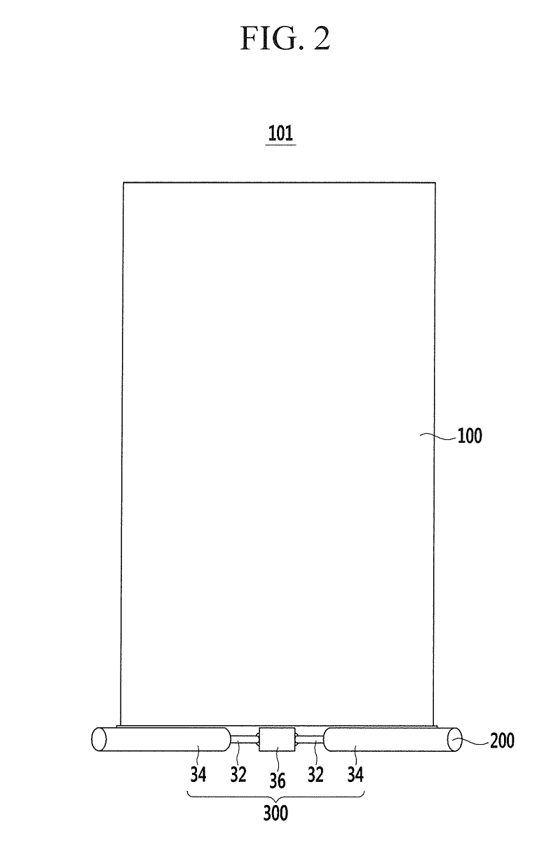

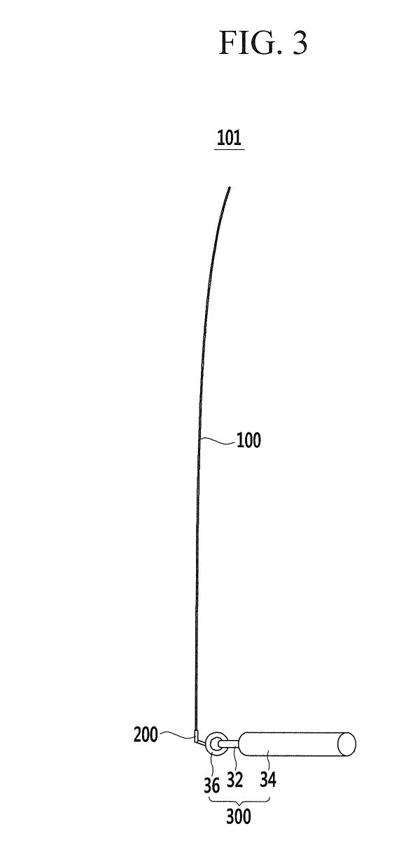

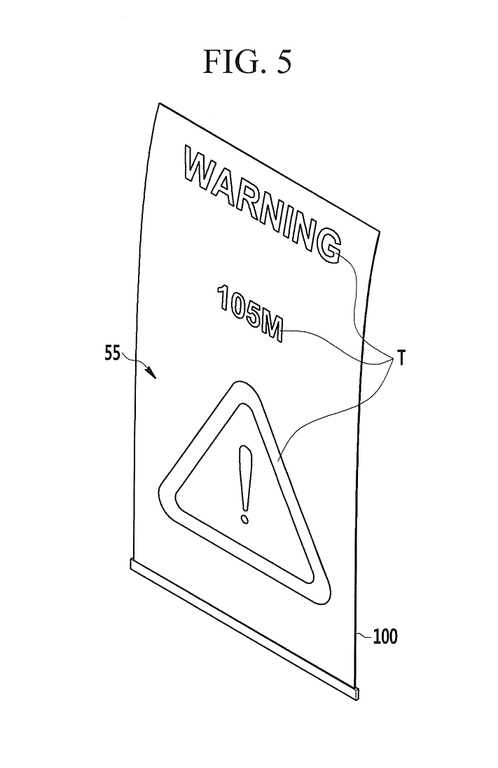

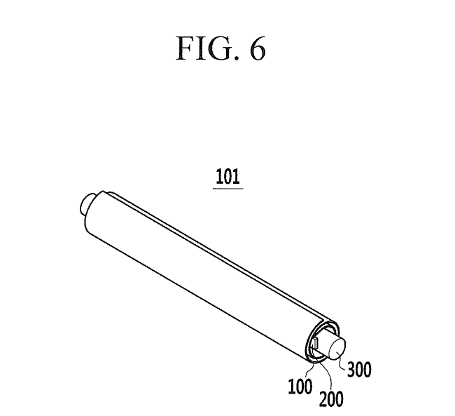

A portable warning system according to an exemplary embodiment of the present invention will be described with reference to FIGS. 1 to 6. FIG. 1 to FIG. 4 are respectively a front view, a rear view, a side view, and a bottom view of a portable warning system according to an exemplary embodiment of the present invention, FIG. 5 is a perspective view of a display unit displaying an alert according to an exemplary embodiment of the present invention, and FIG. 6 is a perspective view showing a storage state of a portable warning system according to an exemplary embodiment of the present invention.

As shown in FIG. 1 to FIG. 4, a portable warning system 101 according to an exemplary embodiment of the present invention includes a display unit 100, a fixing member 200 (e.g., connecting member), and a supporting member 300 (e.g., support base). The portable warning system 101 further includes a distance (e.g., a distance from the portable warning system 101 to a stalled, or wrecked, car) measuring system (not shown).

The display unit 100 may display a picture(s) or a symbol(s) as a transparent flexible substrate including an organic light emitting device, and may have a plate (e.g., planar) shape having a plane pattern of a polygon such as, for example, a quadrangle or a triangle.

The display unit 100 displays a character(s), a picture(s), or a motion picture(s), and may be a flexible organic light emitting diode (OLED) display. The flexible organic light emitting diode (OLED) display for the display unit of embodiments of the present invention may be applied with various organic light emitting diode (OLED) displays known to those skilled in the art. The organic light emitting diode (OLED) display includes a driver (not shown) controlling the display unit 100. The driver may be installed on one side of the display unit 100.

As shown in FIG. 5, the display unit 100 may display a warning, or advisory, to inform drivers of following cars of an accident situation when a traffic accident occurs. Also, the display unit 100 may display a distance from the portable warning system 101 (e.g., the display 100) to the accident scene or the stalled car/wreckage involved in the accident. The display unit 100 may display the distance by receiving a measured value of the distance, the distance being determined through the distance measuring system of the portable warning system 101.

The distance measuring system may be integrated with the car, and may also be integrated with the fixing member 200 or the supporting member 300. The distance measuring system may include a first wireless transmitting/receiving unit coupled to the portable warning system, and a second wireless transmitting/receiving unit coupled to the car. That is, the distance may be measured based upon, for example, a time transmitted when the first wireless transmitting/receiving unit transmits a frequency by using the second wireless transmitting/receiving unit to receive and re-transmit the frequency generated from the first wireless transmitting/receiving unit. This distance measuring system may use various distance measuring systems known to those skilled in an art.

Also, the display unit 100 of the portable warning system 101 may display warnings/advisories such as those instructing a driver to slow his speed, or warning a driver of a detour or construction site ahead. The character(s), the picture(s), and the motion picture(s) shown by the display unit 100 may be automatically displayed in case of emergency after being stored to the memory of the display unit. Also, by connecting the driver to a control device (e.g., a computer), a character(s) and/or a picture(s) desired by a user may be programmed to be displayed by the display unit 100.

The display unit 100 may be formed on a transparent material such that following drivers are able to recognize the accident situation or the construction site that is behind the display unit 100, the image being visible through a portion 55 where the warning expression and picture are otherwise not displayed, thereby obtaining a wide field of view while driving (e.g., the transparent material enables the driver to see through the display unit).

Again referring to FIGS. 1 to 4, the fixing member 200 is attached to the supporting member 300, and a groove (not shown) is formed. One side of the display unit 100 is inserted and fixed to the groove, thus one side of the display unit 100 is straight. That is, by using the fixing member 200 to maintain one side of the display unit 100 as straight during use, the display unit 100 may be rolled by the supporting member 300 during stowage, and the display unit 100 may maintain the plate shape when the display unit 100 is unrolled.

The supporting member 300 has a bar shape to maintain a state (e.g., to keep the display unit 100 upright) such that the following driver may recognize the content of the display unit 100 when the display unit 100 is unrolled.

The supporting member 300 includes a hinge 36 attached or otherwise coupled to the fixing member 200, and a pair of a first bar parts (e.g., first bars) 32 and a pair of second bar parts (e.g., second bars) 34, ones of each of the pairs of the first and second bar parts 32 and 34 being positioned at each of both sides of the hinge.

The fixing member 200 may be attached to the outside of the hinge 36, and both ends of the hinge 36 have a pipe shape of which an inner part is empty.

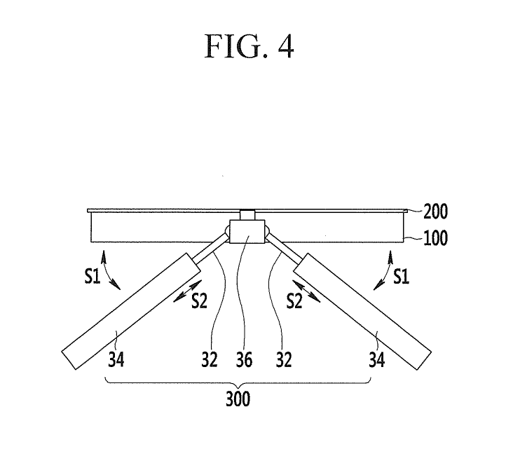

The inner part of the first bar part 32 may be a solid body without an inner cavity, but may be a hollow pipe. One end of each of the first bar parts 32 is coupled to the hinge 36 with respective connection balls having a larger diameter than the main body of the first bar part 32, and each of the connection balls is inserted in respective ends of the hinge 36, thereby forming a joint. By the joint, the first bar part 32 may be rotated and positioned at various angles (referring to reference numeral S1 of FIG. 4).

The second bar part 34 is a pipe having a larger diameter than the main body of the first bar part 32 and being hollow such that the first bar part 32 may be moved (e.g., in a telescoping manner) partially within the second bar part 34 (referring to reference numeral S2 of FIG. 4). A protrusion (not shown) may be formed at one end of the second bar part 34 inserted with the first bar part 32 (e.g., an inward protrusion) and/or at the other end of the first bar part (e.g., an outward protrusion, or flare), thereby preventing separation of the first bar part 32 and the second bar part 34, because of the protrusion(s).

The first bar part 32 is moved within the second bar part 34 such that the entire length of the supporting member 300 may be adjusted. If the display unit 100 is rolled and stored to the supporting member 300, the length of the supporting member 300 is preferably equal to or larger than the length of the fixing member 200, although the first bar part 32 may be completely inserted into the second bar part 34 such that the length of the supporting member 300 is reduced.

The portable warning system 101, which may be used in case of emergency or for informing of a dangerous situation, may be stored in a place such as a trunk of the car. However, if the portable warning system 101 is stored as it is (e.g., in its “set up” form), the portable warning system 101 would occupy most of the trunk of the car, such that other objects may be not placed therein. Accordingly, if the display unit 100 is formed of the flexible substrate, as in the present exemplary embodiment shown in FIG. 6, the portable warning system 101 may be rolled to the supporting member 300, thereby minimizing the volume of the portable warning system 101. To maintain the rolled state of the display unit 100, the portable warning system may further include a fixing band (e.g., a tie-down or strap, not shown).

The portable warning system according to the present embodiment of the present invention may further include a power supply (not shown) to drive the driver and/or the display unit.

As shown in FIG. 6, the portable warning system 101 that is rolled/collapsed and stored is installed to, or set up at, the required place after increasing the length of the supporting member 300, if necessary (referring to the reference numeral S2 of FIG. 4), unrolling the display unit 100, and then rotating the pair of first bar parts 32 and the pair of the second bar parts 34 to form the angle (e.g., a predetermined angle) between the first bar parts 32/second bar parts 34 positioned on respective sides of the hinge (referring to reference numeral S1 of FIG. 4), thereby forming a base of the portable warning system 101.

As described above, the display unit 100 is formed of the flexible substrate including the organic light emitting device such that following drivers may recognize the warning expression on a cloudy day or at night. Also, by displaying the distance from the display unit to the scene of the accident, the following driver may recognize the distance and may be forewarned.

The power supply may be installed to, or coupled with, the fixing member 200, the supporting member 300, or the display unit 100, and includes a rechargeable battery. As shown in FIG. 6, when stored in the rolled state, the rechargeable battery may be rechargeable (e.g., charged by a battery of the car), or may be driven by a separate battery.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and their equivalents.

### DESCRIPTION OF SOME OF THE REFERENCE CHARACTERS

| | |
|---|---|
| 32: first bar part | 34: second bar part |
| 36: hinge | 100: display unit |
| 101: portable warning system | 200: fixing member |
| 300: supporting member | |

What is claimed is:

1. A portable warning system comprising:
a flexible display unit;
a fixing member coupled to one side of the display unit; and
a supporting member coupled to the fixing member and having a bar shape.

2. The portable warning system of claim 1, wherein the display unit comprises an organic light emitting device.

3. The portable warning system of claim 2, wherein the display unit comprises a transparent substrate on which the organic light emitting device is located.

4. The portable warning system of claim 1, wherein the supporting member comprises:
a hinge coupled to the fixing member;
a first bar coupled to an end of the hinge; and
a second bar coupled the first bar,
wherein the first bar is movable with respect to the second bar.

5. The portable warning system of claim 4, wherein the first bar is coupled to the hinge using a ball-and-socket joint.

6. The portable warning system of claim 1, wherein the fixing member comprises a groove, and
wherein one side of the display unit is fixably inserted into the groove.

7. The portable warning system of claim 1, wherein the display unit has a planar shape.

8. The portable warning system of claim 1, further comprising a distance measuring system for calculating a distance from the portable warning system to one or more of a scene of an accident, a construction site, a pedestrian crossing, or a detour.

9. The portable warning system of claim 1, wherein the flexible display unit is collapsible around the supporting member.
